(19) United States
(12) Patent Application Publication
(10) Pub. No.: US 2025/0211645 A1
(43) Pub. Date: Jun. 26, 2025

(54) Managing an Automation System Using a Client Device

(71) Applicant: OliverIQ, Inc, South Jordan, UT (US)

(72) Inventors: Eric Smith, Draper, UT (US); Jory Dunn, West Jordan, UT (US); Mike McNamara, Salt Lake City, UT (US)

(21) Appl. No.: 18/984,755

(22) Filed: Dec. 17, 2024

Related U.S. Application Data
(60) Provisional application No. 63/613,029, filed on Dec. 20, 2023.

(51) Int. Cl. H04L 67/12

(52) U.S. Cl. CPC H04L 67/12

(57) ABSTRACT

A technology is provided for enabling a client device to manage an automation system. A method may include receiving a server reference for a server associated with an automation hub at a client gateway. The server may maintain automation data for the automation hub and is used to manage the automation hub. A server network reference associated with the server may be stored in a data store. Another operation may be receiving a connection request from a client device at the client gateway. The server network reference may be sent to the client device to enable the client device to connect directly to the server.

### BACKGROUND

The wide availability of automation devices (e.g., automated lights, light switches, motion detectors, garage door controllers, etc.), video cameras, large screen TVs, wireless audio equipment, IoT (internet of things) devices, and similar electronic equipment has continued to increase interest in having and maintaining an automation network for home, business or public locations. Over time it has become less expensive and easier to buy many networkable electronic components that can be used to control lighting, garage doors, monitor appliances, stream video or music, and automate a variety of other electronic components using an automation network.

Many automation devices, security systems and other electronic devices can be networked into a central controller or automation hub through a wired or wireless network. Examples of electronic components that an individual may desire to interface with a controller and an automation network can include: television screens, wireless audio equipment, video cameras, microphones, audio-visual and entertainment equipment, Alexa devices, Google devices, etc. Other types of devices that can be in communication with the controller can include automation equipment such as: door locks, lighting control switches, fireplace relays, dimmers, thermostats, HVAC, timers, garage door controllers, alarm systems, security sensor and other types of automation equipment. In addition, other home or business equipment can be connected to a central controller or automation hub of automation network such as: USB devices, FireWire devices, serial and parallel communication devices, fiber optic connections, a computer network using an Ethernet or wireless connection, and Internet connections. These electronic components that have been described can be used many settings, including home, business, education, government, hotels, churches, and entertainment facilities.

### BRIEF DESCRIPTION OF THE DRAWINGS

FIG. 1 is a block diagram illustrating an example of a system that enables a client device to manage an automation hub and/or an automation system.

FIG. 2 illustrates a flowchart of an example method for enabling a client device to manage an automation system.

FIG. 3 is a block diagram illustrating an example of a method for enabling a client device to manage an automation system using a connection index.

FIG. 4 is a block diagram of a service provider environment according to an example of the present technology.

FIG. 5 is a block diagram that provides an example illustration of a computing device that may be employed in the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology includes processes and systems to make remote access for managing an automation system highly responsive when using a client device (e.g., a mobile device, desktop device, laptop, etc.) that is in communication with a server that controls and syncs with automation hubs. The automation system may include an automation hub or central controller at a business, home, government installation or other location that is in communication with a plurality of automation devices. The automation hubs may further control and manage automation devices in the automation system.

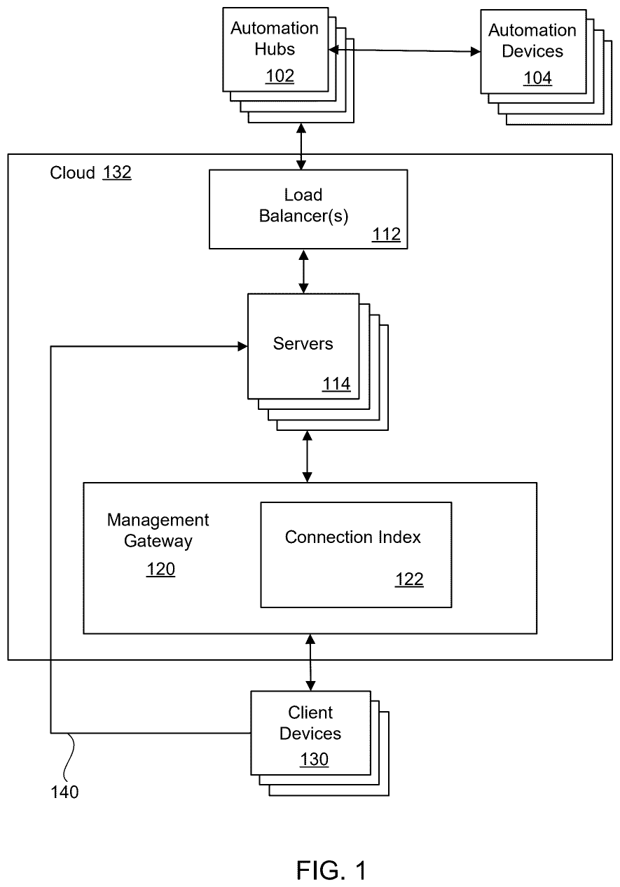

FIG. 1 illustrates that an automation hub 102 may have any number of automation devices 104 (e.g., IoT devices) connected to the automation hub 102. The automation hub 102 may connect to a server 114 in a public service provider environment or a private service provider environment (e.g., a public or private cloud or data center) to allow the automation hub 120 to be managed through the server 114. The server 114 may be include the functions of a management server, a synchronization server or an IoT core server. For example, the client device 130 may be able to: view data collected by the automation hub 102, set states for the automation devices 104 that are sent back to the automation devices to change the automation devices' states, send commands through the server to the automation hub 102 and automation devices 104, obtain data (e.g., sensor data, video, etc.) from the automation devices, etc.

The information from automation hubs 102 at various locations (e.g., multiple locations, businesses, homes, etc.) may be distributed across a plurality of servers 114 in a public service provider environment (i.e., a cloud) using one or more load balancers 112 in order to ensure that individual servers 114 do not become overloaded when receiving data, storing and responding to client devices 130. This distribution of information or connections using the load balancers may use known approaches for load balancing. However, the information for a single automation hub 102 may generally reside on one server 114 unless the information needs to be moved by the load balancer or servers due to space, computing power, bandwidth or similar considerations.

Client devices 130 (e.g., management clients) can connect to the servers 114 using a management gateway 120 that directly instructs the client devices 130 regarding which server 114 in the public service provider system 132 (e.g., public cloud) or private service provider system to connect to, without checking with a load balancer 112, each time requests are made to the server 114. The server(s) 114 may be included in a private service provide environment, a data center, a data warehouse, a server farm or any other centralized and/or virtualized computing environment.

The management gateway 120 can also provide a server address of the server 114 by receiving login credentials or another key, such as a server name or a hash key, to look up the desired servers 114 to which the client device may connect. This allows the client devices 130 be responsive in connecting to servers even though a load balancing approach is being used for connecting automation hubs 102 to servers 114.

Most load balancers 112 have a known type of functionality. The load balancers 112 are located in the network of a public or private service provider (e.g., a cloud provider) or in a data center in the network path for communicating data to and receiving data from a group of servers. A load balancer may decide which server should be used to store the data and serve requests to accessing data and state information for an automation hub 102, by using various routing methods such as: affinity routing, round robin routing, server load, data sharding, or other known load balancing processes. If a client device 130 were to connect to a server 102 through the load balancer 112, the load balancer 112 may take the time to communicate with the servers 114 to find out where the data for a given server 114 is located. This process can be relatively slow and cumbersome.

The automation hub 102 (e.g., central controller, the IoT hub, etc.) may connect to the server 114 selected in order to store the data, states, instructions, and management activity through using existing load balancing methods. This means that each automation hub 102 may end up connected to a server 114, regardless of the type of location where the automation hub is used (e.g., business, home, government location, etc.) Accordingly, the automation hub 102 may read and write data, device states, instructions for other devices, and other automation network information to the server 114. The data and state information on an automation hub 102 may include data and state information from the automation devices 104 in communication with an automation hub 102. This information may be synchronized between the server 114 in the public or private service provider environment (e.g., public cloud or private cloud) and the automation hubs 102 assigned by the load balancer 112.

Later, a user with a client device 130 may want to access the data, states, instructions, etc. on a server 114 corresponding to the user's automation network. When an application (e.g., an app) used for managing an automation network is opened on a client device 130 (e.g., a mobile device), the user wants the application to be quickly responsive in displaying the data and device states for the automation devices 104 connected to the automation hub 102 for the user's network. The user may also want to be able to quickly send instructions to or change the state of the automation devices 104 connected to the automation hub 102. Basically, the user desires to view the data about automation devices 104 and send instructions immediately. For example, the user may open the app on a client device 130 and the user may provide their login credentials. The app may determine which server 114 to connect to by obtaining the server address from the management gateway 120. After directly connecting to the server, the user may view information about the automation devices 104. For example, the user may view data in less than 1 second because the app is directed straight to the server for the respective automation hub.

In some example cases, the servers 114 in the data centers and availability zones for cloud service providers may be in different geographic locations that are distributed over large geographic distances. These geographic distances can slow down the ability to determine or set up a connection between the server 114 and the application on the client device 130. If a load balancer 112 were to be used, the load balancer 112 has to determine which server was being accessed by the automation hub 102 and the load balancer 112 (or hierarchy of load balancers) may be slow in providing this information to a client device 130 because the automation hub 102 must access the server 114 through the load balancing processes 112 to determine which server 114 the automation hub 102 needs to connect to. This may make the app on the client device seem slow and un-responsive.

In order to speed up the connections of the client devices 130 to a server 114, an association may be made between the 1) server's address and 2) the server's name, client login credentials or other logical server identifiers. When the automation hub 102 connects to the server 114 (e.g., in a cloud service) through the load balancer 112, the server 114 associated with specific login credentials (or server name or other server identifier) can be registered in a data store available to the management gateway 120. For example, the data store may be a connection index 122. Accordingly, the server address for a direct connection 140 to the server is in a data listing that references the login credentials or server identifier for the server. This relationship data listing may be stored in a data store in the management gateway 120. For example, a table may be built that references the automation hub 102 and the server 114 which the automation hub is using for storing data, syncing states, setting states and managing related information. The automation hub 102 may be uniquely identified and the login credentials of the owner of the automation hub may also be unique.

For example, when a mobile phone user connects to the management gateway 120, the address of the server 114 associated the login credentials or server identifier is provided back to the mobile phone. This allows the application on the mobile phone to connect directly to the server with the address the mobile phone received. In another example, a plurality of mobile phones (e.g., 6 mobile phones) and a tech support mobile device need to connect to the server. Each of these devices can all connect quickly and directly to the correct server 114 using the address they each receive from the management gateway 120.

If the client application needed to go through a load balancer that communicates with the servers 114, then connecting through the load balancer would be slow because the load balancer may need to use a back end bus to communicate with other load balancers or to communicate with the servers that might have the desired server address and/or network address information. In contrast, the present technology does not need to use a back end bus that is used for communicating with the servers 114 to determine which server 114 has the information for the automation hub 102 associated with the login credentials or other authentication information provided by a client device 130. The use of a back end bus may be slow and the present technology avoids such relatively time consuming communications.

This technology can also report back to the application on the client device 130 regarding whether the automation hub 102 and/or automation system is offline. If the internet connectivity at the location of the automation hub 102 and/or automation system becomes unavailable or is offline, then the application on the client device 130 may be told by the server 114 that the automation hub 102 is offline or unreachable. Then the app on the client device 130 (e.g., a mobile device, a cellphone, a tablet, laptop, etc.) may be instructed to try and connect to the automation hub 102 using a local area network (LAN) with Wi-Fi, Bluetooth or another local networking communication method. If the client device 130 is in a location where the client device 130 can access the same local area network (LAN) (or is within Bluetooth range) that the automation hub 102 is on (e.g., at home or at a business), then the client device can connect to the automation hub locally. The client device 130 can connect to the automation hub by sending out a SSTP (Secure Socket Tunneling Protocol) connection request through the LAN. After the local connection occurs, the application on the client device 130 can report the status of the automation hub 102 to the application on the management gateway or management device. This ability to check the state of automation hub locally can be considered a fail over process.

If the client device 130 is able to connect to the automation hub 102 through the LAN, the client device 130 may collect information from the automation hub 102 about the client devices 130 and their states and then send the information to the server 114 through the management gateway 120 or through a direct connection to the server 114. For example, a mobile device may use its 5G wireless connection to update the state of the automation hub 102 on the server 114. This can push information back to the cloud when the internet has gone down at a specific location (e.g., business, home, government site, public location, etc.). This may be possible because a mobile device may still have a mobile internet connection (e.g., 4G, 5G or in the future 6G) even if the automation hub's 102 wired internet connection is unavailable.

The ability to be able to fail over a client device 130 by using a LAN can be useful in providing support for the automation hub, automation devices and automation network. In the case where an automation hub 102 cannot be reached from the cloud side, then either a router, modem or similar device has failed or there is no internet from the ISP (internet service provider). When such issues arise, the mobile device can connect locally to the automation hub 102 to determine what has failed. This allows a tech support person that is communicating with a user to know whether the automation hub itself still operates properly. Generally, requests from the client device 130 will be routed through the cloud as a default because connecting to the local system first is quite often not available, however, the use of local access to the automation hub 102 can assist with troubleshooting and support.

To summarize, this technology may have a plurality of servers that have many client devices, and the automation hubs 102 connect to the servers 114 through one or more load balancers 112. When the automation hubs 102 connect to the load balancer(s) 112 or servers 114, the name of automation hub 102 or associated credentials and server address can be registered into the data store (e.g., a table, a key-value store, XML, etc.) in the management gateway 120 or client gateway. When a client device 130 connects (that is not an automation hub) to the management gateway 120, that client device 130 may receive the address of the server 114 corresponding to the server name, the authentication credentials or authentication identifier. Then the client device 130 may connect directly to the server 114 to obtain the information about the automation hub 102 and automation network. Thus, the client devices 130 do not connect to the servers 114 through the load balancer 112 to connect to the servers of the system and but rather the client devices 130 connect through a separate management gateway 120 or client gateway to connect to the desired server 114.

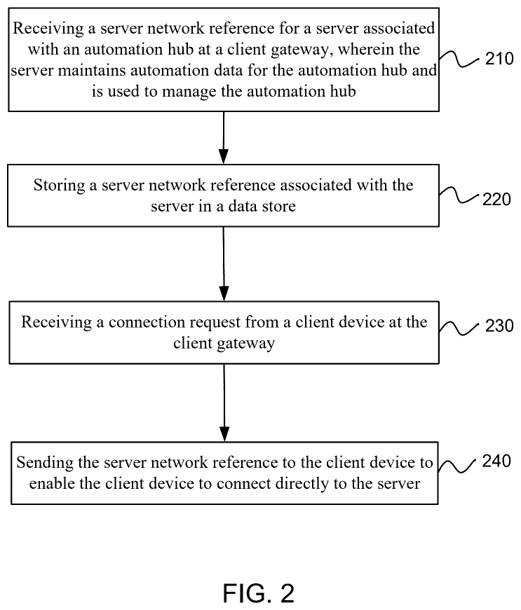

FIG. 2 illustrates a flowchart of a method for enabling a client device to manage an automation system. A server network reference for a server associated with an automation hub at a client gateway may be received, as in block 210. The server may maintain automation data and automation data for the automation hub and may be used to manage the automation hub.

A server network reference associated with the server may be stored in a data store, as in block 220. The data store may be located in a management gateway. A connection request from a client device may be received at the client gateway (e.g., management gateway), as in block 230.

The server network reference may be sent to the client device to enable the client device to connect directly to the server, as in block 240. The server network reference may be: a server URI, server URL, a host name, a server address, a server IP (internet protocol) address, another network address for directly addressing the server, a logical server address that can be converted to a server address (e.g., using DNS) or another server network reference that can be converted to a computer network address.

Data can be received at the client device from the server to allow the client device to display the status of automation devices connected to the automation hub or other automation system related information. The client device may also send instructions from the server to manage automation devices connected to the automation hub. For example, the client device may change the state of or change configurations of an automation device connected to the automation hub. In a more specific example, the automation device may be a light controller where the state of the light is turned off or on. Any other automation state or configuration for an automation device may be changed.

In one situation, a notification may be received at the client device that the automation hub is unreachable by the server in the cloud. As a result, the automation hub may be connected to by the client device (e.g., a mobile device) through a local area network in order to obtain automation device status or automation hub status. The connection to the LAN may be a Wi-Fi connection, a Bluetooth connection, or another type of wireless connection that enables access to a LAN. If the automation hub status is obtained by the user device through the LAN, the client device may send the automation hub status data to the server using the client's devices mobile wireless connection (e.g., a cellphone connection).

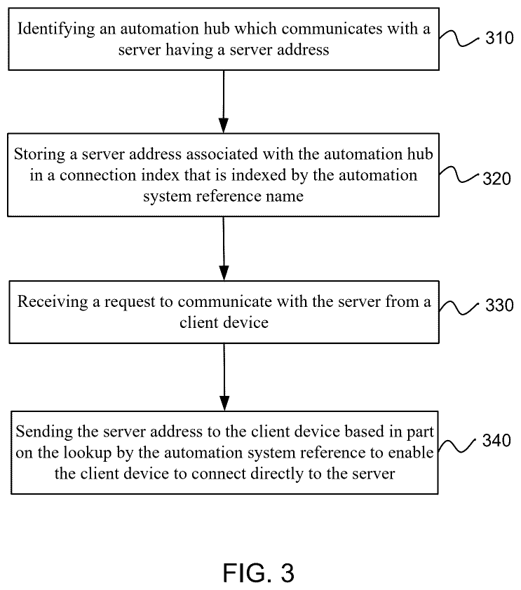

FIG. 3 is a block diagram illustrating a more detailed example method for enabling a client device to manage an automation system. The method may include identifying an automation hub which communicates with a server having a server address, as in block 310.

A server address associated with the automation hub may be stored in a connection index that is indexed by the automation system reference name, as in block 320. A request to communicate with the server may be received from a client device, as in block 330. The client device may be a mobile device, a desktop device, a second server, a service or another other client executing on a device.

The server address can be sent to the client device based in part on the lookup by the automation system reference (e.g., the server name, the authentication credentials or authentication identifier) to enable the client device to connect directly to the server, as in block 340. The client device may receive data from the server to display the status and/or configurations of automation devices connected to the automation hub and/or information about the automation device itself. The server may be located in a public cloud, private cloud or a data center. The data in the server may have been collected because the automation hub can send automation device statuses, its own status data and information about an automation network to the server.

As described earlier, there may be a situation where the internet is not available at a location where an automation hub or automation system resides. As a result, a notification may be received at the client device that the automation hub is unreachable. If the client device is within a wireless proximity of the local area network then the client device can connect to Wi-Fi or another method. Specifically, the mobile device can connect to the automation hub through a local area network in order to obtain automation device status and/or automation hub status. This allows status information related to the automation devices or automation hub to be sent to the server. In addition, the automation device status or automation hub status can be presented on the mobile device.

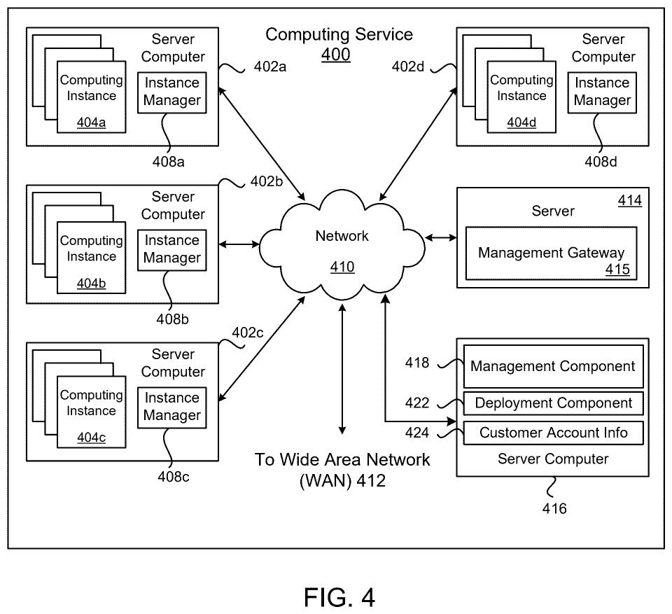

FIG. 4 is a block diagram illustrating an example computing service 400 that may be used to execute and manage a number of computing instances 404a-d upon which the present technology may execute. In particular, the computing service 400 depicted illustrates one environment in which the technology described herein may be used. The computing service 400 may be one type of environment that includes various virtualized service resources that may be used, for instance, to host computing instances 404a-d.

The computing service 400 may be capable of delivery of computing, storage and networking capacity as a software service to a community of end recipients. In one example, the computing service 400 may be established for an organization by or on behalf of the organization. That is, the computing service 400 may offer a “private cloud environment.” In another example, the computing service 400 may support a multi-tenant environment, wherein a plurality of customers may operate independently (i.e., a public cloud environment). Generally speaking, the computing service 400 may provide the following models: Infrastructure as a Service (“IaaS”) and/or Software as a Service (“SaaS”). Other models may be provided. For the IaaS model, the computing service 400 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 400. End customers may access the computing service 400 using networked client devices, such as desktop computers, laptops, tablets, smartphones, etc. running web browsers or other lightweight client applications, for example. Those familiar with the art will recognize that the computing service 400 may be described as a “cloud” environment.

The particularly illustrated computing service 400 may include a plurality of server computers 402a-d. The server computers 402a-d may also be known as physical hosts. While four server computers are shown, any number may be used, and large data centers may include thousands of server computers. The computing service 400 may provide computing resources for executing computing instances 404a-d. Computing instances 404a-d may, for example, be virtual machines. A virtual machine may be an instance of a software implementation of a machine (i.e. a computer) that executes applications like a physical machine. In the example of a virtual machine, each of the server computers 402a-d may be configured to execute an instance manager 408a-d capable of executing the instances. The instance manager 408a-d may be a hypervisor, virtual machine manager (VMM), or another type of program configured to enable the execution of multiple computing instances 404a-d on a single server. Additionally, each of the computing instances 404a-d may be configured to execute one or more applications.

A server 414 may be reserved to execute software components for implementing the present technology or managing the operation of the computing service 400 and the computing instances 404a-d. For example, the server 414 may include a management gateway 415 or client gateway with the functions described earlier. A computing instance 404a-d may also be used as a server for managing the automation network, as described in FIG. 1.

A server computer 416 may execute a management component 418. A customer may access the management component 418 to configure various aspects of the operation of the computing instances 404a-d purchased by a customer. For example, the customer may setup computing instances 404a-d and make changes to the configuration of the computing instances 404a-d.

A deployment component 422 may be used to assist customers in the deployment of computing instances 404a-d. The deployment component 422 may have access to account information associated with the computing instances 404a-d, such as the name of an owner of the account, credit card information, country of the owner, etc. The deployment component 422 may receive a configuration from a customer that includes data describing how computing instances 404a-d may be configured. For example, the configuration may include an operating system, provide one or more applications to be installed in computing instances 404a-d, provide scripts and/or other types of code to be executed for configuring computing instances 404a-d, provide cache logic specifying how an application cache is to be prepared, and other types of information. The deployment component 422 may utilize the customer-provided configuration and cache logic to configure, prime, and launch computing instances 404a-d. The configuration, cache logic, and other information may be specified by a customer accessing the management component 418 or by providing this information directly to the deployment component 422.

Customer account information 424 may include any desired information associated with a customer of the multi-tenant environment. For example, the customer account information may include a unique identifier for a customer, a customer address, billing information, licensing information, customization parameters for launching instances, scheduling information, etc. As described above, the customer account information 424 may also include security information used in encryption of asynchronous responses to API requests. By “asynchronous” it is meant that the API response may be made at any time after the initial request and with a different network connection.

A network 410 may be utilized to interconnect the computing service 400 and the server computers 402a-d, 416. The network 410 may be a local area network (LAN) and may be connected to a Wide Area Network (WAN) 412 or the Internet, so that end customers may access the computing service 400. In addition, the network 410 may include a virtual network overlaid on the physical network to provide communications between the servers 402a-d. The network topology illustrated in FIG. 4 has been simplified, as many more networks and networking devices may be utilized to interconnect the various computing systems disclosed herein.

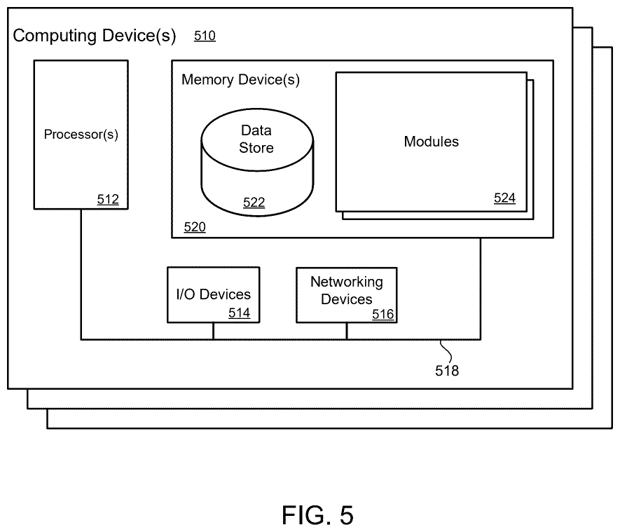

FIG. 5 illustrates a computing device 510 on which modules of this technology may execute. The computing device 510 is illustrated on which a high level example of the technology may be executed. The computing device 510 may include one or more processors 512 that are in communication with memory devices 520. The computing device may include a local communication interface 518 for the components in the computing device. For example, the local communication interface may be a local data bus and/or any related address or control busses as may be desired.

The memory device 520 may contain modules 524 that are executable by the processor(s) 512 and data for the modules 524. The modules 524 may execute the functions described earlier. A data store 522 may also be located in the memory device 520 for storing data related to the modules 524 and other applications along with an operating system that is executable by the processor(s) 512.

Other applications may also be stored in the memory device 520 and may be executable by the processor(s) 512. Components or modules discussed in this description that may be implemented in the form of software using high programming level languages that are compiled, interpreted or executed using a hybrid of the methods.

The computing device may also have access to I/O (input/output) devices 514 that are usable by the computing devices. An example of an I/O device is a display screen that is available to display output from the computing devices. Other known I/O device may be used with the computing device as desired. Networking devices 516 and similar communication devices may be included in the computing device. The networking devices 516 may be wired or wireless networking devices that connect to the internet, a LAN, WAN, or other computing network.

The components or modules that are shown as being stored in the memory device 520 may be executed by the processor 512. The term “executable” may mean a program file that is in a form that may be executed by a processor 512. For example, a program in a higher level language may be compiled into machine code in a format that may be loaded into a random access portion of the memory device 520 and executed by the processor 512, or source code may be loaded by another executable program and interpreted to generate instructions in a random access portion of the memory to be executed by a processor. The executable program may be stored in any portion or component of the memory device 520. For example, the memory device 520 may be random access memory (RAM), read only memory (ROM), flash memory, a solid state drive, memory card, a hard drive, optical disk, floppy disk, magnetic tape, or any other memory components.

The processor 512 may represent multiple processors and the memory 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as separate modules or blocks, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for enabling a client device to manage an automation system, comprising:
receiving a server network reference for a server associated with an automation hub at a client gateway, wherein the server maintains automation data for the automation hub and is used to manage the automation hub;
storing the server network reference associated with the server in a data store;
receiving a connection request from the client device at the client gateway; and
sending the server network reference to the client device to enable the client device to connect directly to the server.

2. The method as in claim 1, wherein the server network reference is at least one of: a server URI, server URL, a host name, or a server IP (internet protocol) address.

3. The method as in claim 1, further comprising receiving data at the client device from the server to display a status of automation devices connected to the automation hub.

4. The method as in claim 1, further comprising sending instructions from the client device to the server to manage automation devices connected to the automation hub.

5. The method as in claim 4, further comprising:
receiving a notification at the client device that the automation hub is unreachable; and
connecting to the automation hub through a local area network using the client device in order to obtain automation device status or automation hub status.

6. A method for enabling a client device to manage an automation system, comprising:
identifying an automation hub which communicates with a server having a server address;
storing the server address associated with the automation hub in a connection index that is indexed by an automation system reference;
receiving a request to communicate with the server from the client device; and
sending the server address to the client device based in part on a lookup by the automation system reference to enable the client device to connect directly to the server.

7. The method as in claim 6, further comprising receiving data at the client device from the server to display a status of automation devices connected to the automation hub.

8. The method as in claim 6, wherein the server is located in a public cloud, private cloud or a data center.

9. The method as in claim 6, wherein the automation hub sends automation device statuses and information about an automation network to the server.

10. The method as in claim 6, wherein the client device is at least one of: a mobile device, a desktop device or a second server.

11. The method as in claim 6, further comprising:
receiving a notification at the client device that the automation hub is unreachable; and
connecting to the automation hub through a local area network using the client device in order to obtain automation device status or automation hub status.

12. The method as in claim 11, further comprising presenting the automation device status or automation hub status on the client device.

13. The method as in claim 11, further comprising sending status information related to an automation device to the server.

14. A non-transitory machine readable storage medium having instructions embodied thereon, the instructions when executed by one or more processors, cause the one or more processors to perform a process including:
receiving a server reference for a server associated with an automation hub at a client gateway, wherein the server maintains automation data for the automation hub and is used to manage the automation hub;
storing a server address associated with the server in a data store;
receiving a connection request from a client device at the client gateway; and
sending the server address to the client device to enable the client device to connect directly to the server.

15. The non-transitory machine readable storage medium as in claim 14, wherein the server address is at least one of: a server URI, server URL, a host name, or a server IP (internet protocol) address.

16. The non-transitory machine readable storage medium as in claim 14, further comprising receiving data at the client device from the server to display a status of automation devices connected to the automation hub.

17. The non-transitory machine readable storage medium as in claim 14, further comprising sending instructions from the client device to the server to manage automation devices connected to the automation hub.

18. The non-transitory machine readable storage medium as in claim 14, further comprising:
receiving a notification at the client device that the automation hub is unreachable; and
connecting to the automation hub through a local area network using the client device in order to obtain automation device status or automation hub status.

19. The non-transitory machine readable storage medium as in claim 14, further comprising presenting an automation device status or automation hub status on the client device.

20. The non-transitory machine readable storage medium as in claim 14, further comprising sending status information related to an automation device to the server.
